(19) United States
(12) Patent Application Publication
(10) Pub. No.: US 2026/0213054 A1
(43) Pub. Date: Jul. 23, 2026

(54) PROCESSING METHOD FOR FERROFLUID USED IN PLASTIC PRODUCTS AND DISPLAY DEVICE

(71) Applicant: Chunjie Zhang, Guangzhou (CN)

(72) Inventor: Chunjie Zhang, Guangzhou (CN)

(21) Appl. No.: 19/026,935

(22) Filed: Jan. 17, 2025

(51) Int. Cl. H01F 1/44; B82Y 30/00; G09F 19/02; H01F 41/00

(52) U.S. Cl. CPC H01F 1/445; B82Y 30/00; G09F 19/02; H01F 41/00

(57) ABSTRACT

A processing method for ferrofluid used in plastic products and a display device are provided, the processing method for ferrofluid used in plastic products includes the following steps: preparing a plastic container and performing a cleaning pretreatment on an inner wall of the plastic container; applying a coating structure onto the inner wall of the plastic container; placing a flowing medium in the plastic container, the coating structure is insoluble in the flowing medium; placing a ferrofluid in the flowing medium, the ferrofluid is insoluble in the coating structure, and the ferrofluid is configured to be moved from a first position to a second position of the flowing medium. The technical solution of the present disclosure can improve the movement smoothness of the ferrofluid.

### TECHNICAL FIELD

The present disclosure relates to the field of ferrofluid technologies, and in particular, to a processing method for ferrofluid used in plastic products and a display device.

### BACKGROUND

Ferrofluid, also known as magnetic liquid, ferrofluid or magnetic fluid, is a new type of functional material that possesses both the fluidity of liquid and the magnetism of solid magnetic materials. It is a stable gel like liquid composed of magnetic solid particles with a diameter in the nanometer range (below 10 nanometers), a carrier liquid (also known as a medium), and an interfacial active agent. Ferrofluid is also applied to display structures; the current toys displayed by ferrofluid all use glass containers, the glass containers are fragile, unsafe, and prone to bottle breakage; which greatly limits the application scenarios of the display structures.

At present, it is necessary to expand the carrier of the display structure so that its application scenarios can be extended to plastic related products, which will enhance the incremental market of the entire ferrofluid application industry; due to a fact that most plastics are lipophilic, ferrofluids may be adhered during the use of plastic products, which will reduce the movement smoothness.

### SUMMARY

The main objective of the present disclosure is to propose a processing method for ferrofluid used in plastic products, aiming to improve a movement smoothness of the ferrofluid.

The above-mentioned problems to be solved by the present disclosure are achieved through the following technical solutions.

A processing method for ferrofluid used in plastic products, including the following steps:

preparing a plastic container and performing a cleaning pretreatment on an inner wall of the plastic container;

applying a coating structure onto the inner wall of the plastic container;

placing a flowing medium in the plastic container, where the coating structure is insoluble in the flowing medium;

placing a ferrofluid in the flowing medium, where the ferrofluid is insoluble in the coating structure, and the ferrofluid is configured to be moved from a first position to a second position of the flowing medium.

In some embodiments of the present disclosure, the coating structure is one or two from hydrophobic and oleophobic organic coating and hydrophobic and oleophobic inorganic coating.

In some embodiments of the present disclosure, when the coating structure is the hydrophobic and oleophobic organic coating, the processing method further includes preparing the organic coating that includes the following steps:

obtaining organic fluororesin, 3-glycidoxypropyltrimethoxysilane, and matting powder with a particle size of 2.6-2.7 μm in a mass ration of 8:0.8:1.6, respectively;

placing the organic fluororesin, 3-glycidoxypropyltrimethoxysilane, and matting powder into butanone and stirring to obtain the hydrophobic and oleophobic organic coating.

In some embodiments of the present disclosure, when the coating structure is the hydrophobic and oleophobic inorganic coating, the processing method includes preparing the inorganic coating that includes the following steps:

after mixing ethanol with water in a mass ratio of 4:1, adding gas-phase silica with a particle size of 50-55 nm, perfluorodecyltrimethoxysilane, and N-(2-aminoethyl)-3-aminopropyltriethoxysilane in a mass ratio of (0.7-0.9):1.2:0.8 into a first container, stirring and mixing;

after a first preset time, adding 4 g of 6 wt % acetic acid aqueous solution and mixing;

heating the first container for a second preset time to obtain the hydrophobic and oleophobic inorganic coating.

In some embodiments of the present disclosure, the ferrofluid is a water-based ferrofluid or an oil-based ferrofluid; the flowing medium is an oily liquid or an aqueous liquid.

In some embodiments of the present disclosure, when the ferrofluid is the water-based ferrofluid and the flowing medium is the oily liquid, the processing method further includes the following:

adding N₂ into a mixed solution of Fe³⁺ and Fe²⁺ with a molar ratio of 3:2 to remove oxygen in the mixed solution, adjusting a pH value of the mixed solution to 7-8, heating the mixed solution to 90° C., stirring at constant temperature for 40 min, filtering and screening out solid, and cleaning to obtain nanometer Fe₃O₄;

adding the nano Fe₃O₄ into polyethylene glycol, stirring with a stirrer for 18-20 hours, washing repeatedly with deionized water and anhydrous ethanol until a cleaning solution is neutral, then diluting with deionized water to a concentration of the nano Fe₃O₄ being 0.09-0.1 g/ml, and performing an ultrasound treatment for 36-40 min to form an aqueous ferrofluid.

In some embodiments of the present disclosure, when ferrofluid is the oil-based ferrofluid and the following medium is the aqueous liquid, the processing method further includes the following:

dispersing magnetite particles in an oil-based dispersion medium in a presence of a surfactant to produce the oil-based ferrofluid;

where the surfactant is selected from one of oleic acid, stearic acid, or lauric acid.

A display device, where it is made by the processing method for ferrofluid used in plastic products; the display device includes a plastic container, a ferrofluid, a flowing medium, and a coating structure; the plastic container is provided with a placement cavity, and the flowing medium is placed in the placement cavity; the ferrofluid is provided in the flowing medium and is insoluble in the flowing medium; the coating structure is connected to an inner wall of the plastic container, and the coating structure is insoluble in the flowing medium; the ferrofluid is insoluble in the coating structure.

In some embodiments of the present disclosure, the coating structure includes a hydrophobic and oleophobic organic coating, and the organic coating is provided on an inner wall of the plastic container; or

the coating structure includes a hydrophobic and oleophobic inorganic coating, and the inorganic coating is provided on the inner wall of the plastic container; or

the coating structure includes at least two hydrophobic and oleophobic organic coatings and at least two hydrophobic and oleophobic inorganic coatings, where the organic coatings and the inorganic coatings are arranged alternately.

In some embodiments of the present disclosure, the ferrofluid is a water-based ferrofluid or an oil-based ferrofluid, the flowing medium is an oily liquid or a water-based liquid;

when the ferrofluid is the water-based ferrofluid, the flowing medium is the oil-based liquid;

when the ferrofluid is the oil-based ferrofluid, the flowing medium is the water-based liquid.

Beneficial effects: the technical solution of the present disclosure adopts preparing a plastic container and performing a cleaning pretreatment of an inner wall of the plastic container to obtain an environment suitable for applying a coating structure, which is conducive to ensuring the coating quality of the coating structure; then applying the coating structure to the inner wall of the plastic container to obtain a structure that avoids adhesion between the ferrofluid and the plastic container. Finally, the flowing medium and ferrofluid are placed inside the plastic container to enable the ferrofluid to move flexibly from a first position to a second position. Furthermore, it can achieve a flexible movement of the ferrofluid in the flowing media, which is conducive to improving a movement smoothness of the ferrofluid and avoiding adhesion between the ferrofluid and the plastic products.

### BRIEF DESCRIPTION OF DRAWINGS

In order to provide a clearer explanation of the embodiments of the present disclosure or the technical solutions in the prior art, a brief introduction will be given to the accompanying drawings required for a description of the embodiments or the prior art. It is obvious that the accompanying drawings described below are only some embodiments of the present disclosure. For those skilled in the art, other drawings can be obtained based on the structures shown in these drawings without creative work.

FIG. 1 is a flowchart of a processing method for ferrofluid used in plastic products in an embodiment according to the present disclosure.

FIG. 2 is a schematic structural diagram of a display device in an embodiment according to the present disclosure.

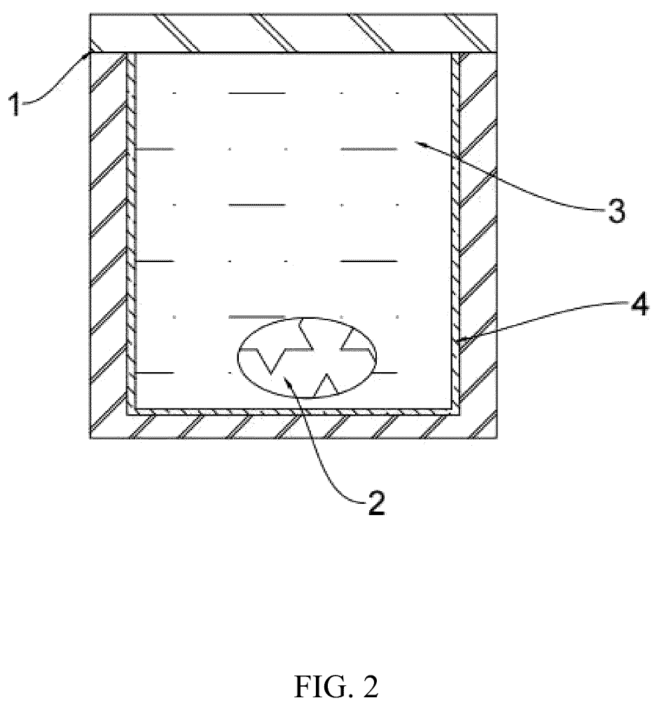

Numeral reference: 1—plastic container; 2—ferrofluid; 3—flowing media; 4—coating structure.

### DESCRIPTION OF EMBODIMENTS

Below, the technical solutions in the embodiments of the present disclosure will be clearly and completely described in combination with the accompanying drawings. Obviously, the described embodiments are only a part of the embodiments of the present disclosure, not all of them. Based on the embodiments of the present disclosure, all other embodiments obtained by those skilled in the art without creative work are within the protection scope of the present disclosure.

It should be noted that if directional indications (such as up, down, left, right, front, back, etc.) are involved in the embodiments of the present disclosure, the directional indications are only used to explain a relative position relationship, motion, etc. between the components in a specific posture. If the specific posture is changed, the directional indications will also be changed accordingly.

In addition, if there are descriptions related to “first”, “second”, etc. in the embodiments of the present disclosure, the descriptions of “first”, “second”, etc. are only for descriptive purposes and cannot be understood as indicating or implying their relative importance or implying the number of technical features indicated. Therefore, the features that are limited to “first” and “second” can explicitly or implicitly include at least one of these features. In addition, if “and/or” or “as well as/or” appears throughout the description, its meaning includes three parallel schemes. Taking “A and/or B” as an example, it includes schemes A, B, or both A and B. In addition, the technical solutions between various embodiments can be combined with each other, but they must be based on the ability of those skilled in the art to implement them. When a combination of technical solutions is contradictory or impossible to implement, it should be considered that this combination of technical solutions does not exist and is not within the protection scope of the present disclosure.

The present disclosure proposes a processing method for ferrofluid used in plastic products.

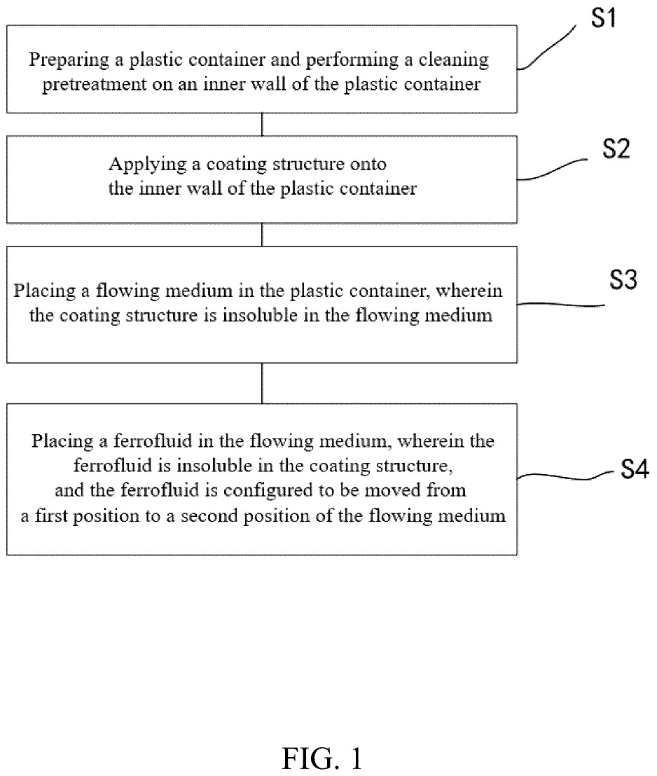

As shown in FIG. 1, in an embodiment of the present disclosure, the processing method for ferrofluid used in plastic products includes the following steps:

S1: preparing a plastic container and performing a cleaning pretreatment on an inner wall of the plastic container;

S2: applying a coating structure onto the inner wall of the plastic container;

S3: placing a flowing medium in the plastic container, where the coating structure is insoluble in the flowing medium;

S4: placing a ferrofluid in the flowing medium, where the ferrofluid is insoluble in the coating structure, and the ferrofluid is configured to be moved from a first position to a second position of the flowing medium.

The technical solution of the present disclosure involves preparing a plastic container and performing a cleaning pretreatment on an inner wall of the plastic container to obtain an environment suitable for applying a coating structure, which is beneficial for ensuring the coating quality of the coating structure; then applying the coating structure to an inner wall of the plastic container to obtain a structure that avoids adhesion between the ferrofluid and the plastic container. Finally, the flowing medium and the ferrofluid are placed inside the plastic container to enable the ferrofluid to move flexibly from a first position to a second position. Furthermore, it can achieve a flexible movement of the ferrofluid in the flowing media, which is conducive to improving the movement smoothness of the ferrofluid and avoiding adhesion between the ferrofluid and the plastic products.

In an implementation mode, the step of preparing a plastic container and performing a cleaning pretreatment on an inner wall of the plastic container in S1 includes the following:

obtaining a main container and a sealing body of the plastic container separately through a thermoplastic machine, and allowing them to stand for a first preset time, that is, preparing the plastic container;

performing water and dust removal treatments separately on the main container and the sealing body, that is the cleaning pretreatment. By produced main container and sealing body, as well as the main container and sealing body were used to contain the flowing medium and ferrofluid; staying, water removal, and dust removal treatments, the inner wall of the plastic container forms an environment suitable for an installation of the coating structure, which is conducive to improving the installation quality of the coating structure.

Where, in an implementation mode, the plastic container 1 is a polystyrene plastic container, and the flowing medium 3 is oily liquid of hydrocarbon oil.

Where, in an implementation mode, the plastic container 1 is a polyethylene terephthalate container; the flowing medium 3 is an oily liquid selected from hydrocarbon oil, fluorinated oil, fluorinated hydrocarbon oil, chlorinated hydrocarbon oil, glyceride, or methyl methacrylate grease.

Where, in an implementation mode, the plastic container 1 is a polymethyl methacrylate plastic; and the flowing medium 3 is an oily liquid selected from a group consisting of hydrocarbon oil, fluorinated oil, fluorinated hydrocarbons, glycerides, or methyl methacrylate esters.

Where, in an implementation mode, the plastic container 1 is an acrylonitrile butadiene and styrene ternary polymer container; the flowing medium 3 is an aqueous liquid of water.

In an implementation mode, one or both of hydrophobic and oleophobic organic coatings and hydrophobic and oleophobic inorganic coatings are selected for the coating structure; where the organic coating uses the organic fluororesin coating; in an implementation mode, the hydrophobic and oleophobic coating body includes an inorganic coating; where, the inorganic coating is a silica coating; in an implementation mode, the coating body includes at least two organic coatings and at least two inorganic coatings, where the organic coatings and the inorganic coatings are alternately arranged.

In an implementation mode, when the coating structure is the hydrophobic and oleophobic organic coating; in S2, preparing the organic coating includes the following steps:

obtaining organic fluororesin, 3-glycidoxypropyltrimethoxysilane, and matting powder with a particle size of 2.6-2.7 μm in a mass ratio of 8:0.8:1.6, respectively;

obtaining 8-9 g of organic fluororesin, 0.7-0.9 g of 3-glycidoxypropyltrimethoxysilane, and 1.5-1.8 g of matting powder with a particle size of 2.6-2.7 μm, respectively;

placing the organic fluororesin, 3-glycidoxypropyltrimethoxysilane, and matting powder into butanone and stirring to obtain the hydrophobic and oleophobic organic coating. Where, a stirring speed is 2000 r/min; a stirring time is 40-45 min; this process can quickly obtain the organic coating with better hydrophobic and oleophobic properties, thereby improving processing efficiency, avoiding adhesion between the ferrofluid and the hydrophobic and oleophobic organic coating, and improving the movement smoothness of the ferrofluid.

In an implementation mode, when the coating structure is the hydrophobic and oleophobic inorganic coating; in S2, preparing the inorganic coating includes the following steps:

after mixing 80 g of ethanol with 20 g of water evenly, adding 0.7-0.9 g of gas-phase silica with a particle size of 50-55 nm, 1.2 g of perfluorodecyltrimethoxysilane, and 0.8 g of N-(2-aminoethyl)-3-aminopropyltriethoxysilane into a first container, stirring and mixing;

after a first preset time, adding 4 g of 6 wt % acetic acid aqueous solution and mixing;

heating the first container for a second preset time to obtain the hydrophobic and oleophobic inorganic coating. Where a stirring speed is 2500 r/min, the first preset time is 25 min, a heating temperature is 80 degrees; the second preset time is 11 hours. This process can quickly obtain the hydrophobic and oleophobic inorganic coating with better performance, thereby improving processing efficiency, avoiding adhesion between the ferrofluid and the hydrophobic and oleophobic inorganic coating, and improving the movement smoothness of the ferrofluid.

In an implementation mode, the ferrofluid 2 is a water-based ferrofluid or an oil-based ferrofluid; the flowing medium 3 is an oily liquid or an aqueous liquid.

In an implementation mode, when the ferrofluid 2 is the water-based ferrofluid and the flowing medium 3 is the oily liquid; in an implementation mode, when the ferrofluid 2 is the oil-based ferrofluid, the flowing medium 3 is the aqueous liquid.

In an implementation mode, when the ferrofluid 2 is the water-based ferrofluid and the flowing medium 3 is the oily liquid; in S4, the step of preparing a ferrofluid includes the following:
adding N₂ into a mixed solution of Fe³⁺and Fe²⁺with a molar ratio of 3:2 to remove oxygen from the mixture, adding NaOH solution to adjust a pH of the mixture to 7-8; heating the mixture to 90° C., stirring at a constant temperature for 40 min, filtering and screening out solid, and cleaning to obtain nanometer Fe₃O₄;
adding the nano Fe₃O₄ into polyethylene glycol, stirring with a stirrer for 18-20 hours, washing repeatedly with deionized water and anhydrous ethanol until a cleaning solution is neutral, then diluting with deionized water to a concentration of the nano Fe₃O₄ being 0.09-0.1g/ml, and performing an ultrasound treatment for 36-40 min to form the aqueous ferrofluid.

In an implementation mode, when the ferrofluid 2 is the oil-based ferrofluid and the flowing medium 3 is the aqueous liquid; in S4, the step of preparing a ferrofluid includes the following:
dispersing magnetite particles in an oil-based dispersion medium in a presence of a surfactant to produce the oil-based ferrofluid; where the surfactant is selected from one of oleic acid, stearic acid, or lauric acid. The surfactant or epoxy resin were used to hydrophilic treat the magnetite particles to render them have a hydrophilic layer, and then subjecting magnetite particles to corona treatment to render them non-magnetic and have the hydrophilic layer on the metal component.

The present disclosure further proposes a display device that uses processing method for ferrofluid used in plastic products as described above. The specific content of the processing method for ferrofluid used in plastic products refers to the above embodiments. Since the display device adopts all the technical solutions of the above embodiments, it at least has all the beneficial effects brought by the technical solutions of the above embodiments, which will not be repeated here. The display device includes a plastic container 1, a ferrofluid 2, a flowing medium 3, and a coating structure 4; the plastic container 1 is provided with a placement cavity, and the flowing medium 3 is placed in the placement cavity; the ferrofluid 2 is provided in the flowing medium 3 and is insoluble in the flowing medium 3; the coating structure 4 is connected to an inner wall of the plastic container 1, and is insoluble in the flowing medium 3; the ferrofluid 2 is insoluble in the coating structure 4.

Due to oleophilic properties of the plastic container 1, the coating structure 4 is provided on the inner wall of plastic container 1 to separate the ferrofluid 2 from the inner wall of the plastic container 1, and the ferrofluid 2 is insoluble in the coating structure 4, which can achieve non adhesion of ferrofluid to the inner wall of plastic container 1, therefor improving a movement smoothness of the ferrofluid, and it is beneficial for enhancing the viewing comfort of the display devices. Besides that, the plastic container has strong flexibility, which overcomes the personal safety hazards caused by the fragility of glass and expands the age and population of toy use, thereby improving its application scenarios and efficiency.

Where, the plastic container 1 includes a main container and a sealing body connected to an upper end of the main container, the coating structure 4 is provided on the inner wall of the main container and the inner wall of the sealing body; the ferrofluid 2 and the flowing medium 3 are respectively placed inside the main container.

Where, the coating structure 4 includes a hydrophobic and oleophobic coating body. In an implementation mode, the hydrophobic and oleophobic coating body includes an organic coating provided on the inner wall of the plastic container; where the organic coating is an organic fluororesin coating. In an implementation mode, the hydrophobic and oleophobic coating body includes an inorganic coating, which is provided on the inner wall of the plastic container. Where, the inorganic coating is a silica coating. In an implementation mode, the hydrophobic and oleophobic coating body includes at least two organic coatings and at least two inorganic coatings, where the organic coatings and the inorganic coatings are alternately arranged. Where the inorganic coating is a silica coating, and the organic coating is an organic fluororesin coating, thereby improving the hydrophobic and oleophobic efficiency of the coating structure to ensure the movement smoothness of the ferrofluid.

The ferrofluid 2 is a water-based ferrofluid or an oil-based ferrofluid; and the flowing medium 3 is an oil-based or a water-based liquid. In an implementation mode, when the ferrofluid 2 is the water-based ferrofluid, the flowing medium 3 is the oil-based liquid. In an implementation mode, when the ferrofluid 2 is the oil-based ferrofluid, the flowing medium 3 is the aqueous liquid.

In an implementation mode, when the plastic container 1 is a polystyrene plastic container, the flowing medium 3 is an oily liquid of hydrocarbon oil.

In an implementation mode, the plastic container 1 is a polyethylene terephthalate container, the flowing medium 3 is an oily liquid selected from hydrocarbon oil, fluorinated oil, fluorinated hydrocarbon oil, chlorinated hydrocarbon oil, glyceride, or methyl methacrylate grease.

In an implementation mode, when the plastic container 1 is a polymethyl methacrylate plastic, the flowing medium 3 is an oily liquid selected from a group consisting of hydrocarbon oil, fluorinated oil, fluorinated hydrocarbons, glycerides, or methyl methacrylate esters.

In an implementation mode, when the plastic container 1 is an acrylonitrile butadiene and styrene ternary polymer container, the flowing medium 3 is an aqueous liquid of water.

The above description is only preferred embodiments of the present disclosure and does not limit the scope of the present disclosure. Any equivalent structural transformation made using the content of this specification and drawings, or directly/indirectly applied in other related technical fields, under the inventive concept of the present disclosure, is included in the protection.

What is claimed is:

1. A processing method for ferrofluid used in plastic products, comprising the following steps:
preparing a plastic container and performing a cleaning pretreatment on an inner wall of the plastic container;
applying a coating structure onto the inner wall of the plastic container;
placing a flowing medium in the plastic container, wherein the coating structure is insoluble in the flowing medium;
placing a ferrofluid in the flowing medium, wherein the ferrofluid is insoluble in the coating structure, and the ferrofluid is configured to be moved from a first position to a second position of the flowing medium.

2. The processing method for ferrofluid used in plastic products according to claim 1, wherein the coating structure is one or two from hydrophobic and oleophobic organic coating and hydrophobic and oleophobic inorganic coating.

3. The processing method for ferrofluid used in plastic products according to claim 2, wherein when the coating structure is the hydrophobic and oleophobic organic coating, the processing method further comprises preparing the organic coating that comprises the following steps:
obtaining organic fluororesin, 3-glycidoxypropyltrimethoxysilane, and matting powder with a particle size of 2.6-2.7 μm in a mass ration of 8:0.8:1.6, respectively;
placing the organic fluororesin, 3-glycidoxypropyltrimethoxysilane, and matting powder into butanone and stirring to obtain the hydrophobic and oleophobic organic coating.

4. The processing method for ferrofluid used in plastic products according to claim 2, wherein when the coating structure is the hydrophobic and oleophobic inorganic coating, the processing method comprises preparing the inorganic coating that comprises the following steps:
after mixing ethanol with water in a mass ratio of 4:1, adding gas-phase silica with a particle size of 50-55 nm, perfluorodecyltrimethoxysilane, and N-(2-aminoethyl)-3-aminopropyltriethoxysilane in a mass ratio of (0.7-0.9):1.2:0.8 into a first container, stirring and mixing;
after a first preset time, adding 4 g of 6 wt % acetic acid aqueous solution and mixing;
heating the first container for a second preset time to obtain the hydrophobic and oleophobic inorganic coating.

5. The processing method for ferrofluid used in plastic products according to claim 1, wherein the ferrofluid is water-based ferrofluid or oil-based ferrofluid, and the flowing medium is an oily liquid or an aqueous liquid.

6. The processing method for ferrofluid used in plastic products according to claim 5, wherein when the ferrofluid is the water-based ferrofluid and the flowing medium is the oily liquid, the processing method further comprises the following:
adding N₂ into a mixed solution of Fe³⁺ and Fe²⁺ with a molar ratio of 3:2 to remove oxygen in the mixed solution, adjusting a pH value of the mixed solution to 7-8, heating the mixed solution to 90° C., stirring at constant temperature for 40 min, filtering and screening out solid, and cleaning to obtain nanometer Fe₃O₄;
adding the nano Fe₃O₄ into polyethylene glycol, stirring with a stirrer for 18-20 hours, washing repeatedly with deionized water and anhydrous ethanol until a cleaning solution is neutral, then diluting with deionized water to a concentration of the nano Fe₃O₄ being 0.09-0.1 g/ml, and performing an ultrasound treatment for 36-40 min to form an aqueous ferrofluid.

7. The processing method for ferrofluid used in plastic products according to claim 5, wherein when the ferrofluid is the oil-based ferrofluid and the following medium is the aqueous liquid, the processing method further comprises the following:
dispersing magnetite particles in an oil-based dispersion medium in a presence of a surfactant to produce the oil-based ferrofluid;
wherein the surfactant is selected from one of oleic acid, stearic acid, or lauric acid.

8. A display device, wherein it is made by the processing method for ferrofluid used in plastic products according to claim 1;
the display device comprises a plastic container, a ferrofluid, a flowing medium, and a coating structure;
the plastic container is provided with a placement cavity, and the flowing medium is placed in the placement cavity;
the ferrofluid is provided in the flowing medium and is insoluble in the flowing medium;
the coating structure is connected to an inner wall of the plastic container, and the coating structure is insoluble in the flowing medium; the ferrofluid is insoluble in the coating structure.

9. The display device according to claim 8, wherein the coating structure comprises a hydrophobic and oleophobic organic coating, and the organic coating is provided on an inner wall of the plastic container; or
the coating structure comprises a hydrophobic and oleophobic inorganic coating, and the inorganic coating is provided on the inner wall of the plastic container; or
the coating structure comprises at least two hydrophobic and oleophobic organic coatings and at least two hydrophobic and oleophobic inorganic coatings, wherein the organic coatings and the inorganic coatings are arranged alternately.

10. The display device according to claim 8, wherein the ferrofluid is a water-based ferrofluid or an oil-based ferrofluid, the flowing medium is an oily liquid or a water-based liquid;
wherein when the ferrofluid is the water-based ferrofluid, the flowing medium is the oil-based liquid;
when the ferrofluid is the oil-based ferrofluid, the flowing medium is the water-based liquid.
